(19) United States
(12) Patent Application Publication
(10) Pub. No.: US 2016/0334263 A1
(43) Pub. Date: Nov. 17, 2016

(54) Aging compensation and temperature compensation of a photomultiplier in a radiometric measurement device having a scintillator arrangement

(71) Applicant: VEGA Grieshaber KG, Wolfach (DE)

(72) Inventor: Matthias HARTER, Schenkenzell (DE)

(21) Appl. No.: 15/138,844

(22) Filed: Apr. 26, 2016

(30) Foreign Application Priority Data
May 13, 2015 (EP) 15 167 652.5

(51) Int. Cl. G01F 23/288

(52) U.S. Cl. CPC G01F 23/288; G01T 1/2018

(57) ABSTRACT

A radiometric fill level measurement device includes a scintillator arrangement and two photon counters. The measurement signals generated by the two photon counters can be compared with one another, thus increasing the measurement accuracy and the stability of the measurement signals.

### REFERENCE TO RELATED APPLICATIONS

This application claims the benefit of the filing date of European Patent Application Serial No. 15 167 652.5 filed on 13 May 2015, the disclosure of which is hereby incorporated herein by reference.

### FIELD OF THE INVENTION

The invention relates to the radiometric measurement of a fill level. The invention relates in particular to fill level measurement devices for radiometrically measuring the fill level and limit level or for measuring density or mass flow rate, and to a method for measuring the fill level in a container, to a program element and to a computer-readable medium.

### BACKGROUND

Radiometric fill level measurement devices can be used to measure the fill level of a fluid in a container. A combination of a transmitter and a radiometric fill level measurement device is used to radiometrically measure the fill level. The transmitter is arranged on an outer container wall and emits a radioactive signal in the direction of the container, a filling material, for example a fluid, being present inside the container at a certain filling level. The radioactive substance used in the transmitter is typically a gamma emitter. A radiometric fill level measurement device is attached to the outer container wall opposite the transmitter. This measurement device detects the proportion of the radiation emitted by the transmitter in the direction of the container that is transmitted through the container walls, the ambient air and the filling material as far as the fill level measurement device, and evaluates this proportion. Depending on the density of the filling material, for example of a liquid, in the container and on the filling level of the filling material, only a certain proportion of the emitted radioactive radiation is transmitted and can be detected by the radiometric fill level measurement device. On the basis of the measured count rate, which is a measure of the incoming radioactive radiation, the filling level can then be determined by the radiometric fill level measurement device.

Radiometric fill level measurement devices comprise a scintillator on which the gamma rays emitted by the transmitter and transmitted as far as the fill level measurement device can impinge, and which converts the received gamma rays into light signals. A photon counter that converts the quantity of light produced in the scintillator into an electrical pulse is connected to the scintillator. This electrical pulse can be evaluated by an evaluation unit of the fill level measurement device and is a measure of the radioactive radiation detected at the scintillator. A photomultiplier can be used, for example, as the photon counter connected downstream of the scintillator. Photomultipliers of this type can experience changes caused by aging or temperature, on account of which the measurement signal that is produced by the photomultiplier and is further processed in the evaluation unit of the fill level measurement device is unstable and inaccurate.

### SUMMARY OF THE INVENTION

According to one aspect of the invention, a fill level measurement device for radiometrically measuring the fill level is proposed, which comprises a scintillator arrangement, a first and a second photon counter that count the photons generated by the scintillator arrangement, a comparator and an evaluation unit. The comparator comprises, for example, a processor unit (microcontroller) or an FPGA (field programmable gate array). The comparator is intended to compare the measurement signals generated by the first and second photon counter with one another. This allows a change, caused by aging or temperature, in the measurement signals generated by the first photon counter to be detected. The evaluation unit can be designed to evaluate the measurement signals generated by the first photon counter, the evaluation being carried out taking into account the detected change caused by aging or temperature. Thus, a greater degree of measurement accuracy and measurement stability may be achieved.

Taking into account the effect of aging or temperature and an associated change caused by aging or temperature is understood to mean that a correction factor for example can be determined for the first photon counter from the comparison of the measurement signals generated by the first and the second photon counter, and the evaluation is carried out taking into account the correction factor which can compensate for the effect of aging, for example. Additional possible ways of taking into account a detected change caused by aging or temperature can also be found in the following description.

The second photon counter can be used to generate a reference measurement signal that can be compared with the measurement signal from the first photon counter in order to determine the effect of a change, caused by aging or temperature, in the measurement signal from the first photon counter. According to one embodiment of the invention, the measurement signal from the second photon counter is not forwarded to the evaluation unit. However, the measurement signals generated by the second photon counter may also be transmitted to the evaluation unit for further evaluation and in particular for determining a fill level.

According to one embodiment of the invention, the second photon counter is temperature-stable. Selecting a temperature-stable second photon counter can ensure that a change, which is caused by temperature, in the measurement signal from the first photon counter can be detected using the measurement signal generated by the second photon counter. In this context, “temperature-stable” should be understood as meaning that the measurement signals obtained by means of the second photon counter are stable and reproducible across the temperature range prevailing in a typical measurement environment.

According to one embodiment of the invention, the first photon counter can be formed as a photomultiplier.

According to another embodiment, an avalanche photodiode can be provided as the second photomultiplier.

According to another embodiment, a fill level measurement device is proposed, the scintillator arrangement of which comprises two scintillators, the first photon counter being designed to receive the light signals produced in the first scintillator, and the second photon counter being designed to receive the light signals generated in the second scintillator.

According to another embodiment, the radiometric fill level measurement device can be designed such that the scintillator arrangement has just one scintillator and the first and second photon counters receive the light signals from this one scintillator.

According to another embodiment of the invention, the radiometric fill level measurement device can also comprise a power supply unit that provides the supply voltage to the first photon counter and can be actuated by a control unit, for example the comparator or an additional control element, for example a second microcontroller, of the fill level measurement device. In this case, the control unit can be designed to vary the supply voltage to the first photon counter that is provided by the power supply unit in the event that a change, caused by temperature or aging, in the measurement signals from the first photon counter was detected when comparing the measurement signals generated by the first and the second photon counter. In the event that the control unit is designed as an element of the fill level measurement device that is not the comparator, the comparator may first transmit data or information to the control unit which is based on the comparison of the measurement data from the first and the second photon counter, and the control unit may then vary the supply voltage to the first photon counter on the basis of said data.

The supply voltage to the first photon counter can be altered in this case until the comparison of the measurement signals generated by the first and the second photon counter results in the measurement signals corresponding or a predetermined target value being reached. In this case, a target value can be a predefined ratio of the measurement signal generated by the first photon counter to the measurement signal generated by the second photon counter, for example. In addition, a tolerance interval can also be specified, within which the ratio between the measurement values generated is intended to lie. A change, which is caused by aging or temperature, in the measurement signals generated by the first photon counter can be compensated for by suitably altering the supply voltage.

An input apparatus can be connected to the comparator, for example, into which apparatus a desired ratio between the measurement signals, or an interval within which the ratio between the measurement signals is intended to lie, can be input. The above-described input apparatus can also directly form part of the comparator.

An input apparatus also makes it possible, for example, to recalibrate a radiometric fill level measurement device, which may be necessary for example when replacing one of the two photon counters. One of the photon counters of the radiometric fill level measurement device can, for example, be replaced with another photon counter. The replacement photon counter can generate a measurement signal, for example, which differs from the measurement signal generated by the replacement photon counter by the intensity thereof. Corresponding data relating to the sensitivity and/or type of photon counter may be input into the input apparatus. A target value or a tolerance interval for the ratio between the measurement signals determined by the first and the second photon counter may also be directly input into the input apparatus, for example.

According to another embodiment of the invention, the comparator of the fill level measurement device may be designed to determine a correction factor from the comparison of the measurement signal recorded by the first and the second photon counter. The comparator may also be designed to deliver this correction factor to the evaluation unit for further evaluation of the measurement signal recorded by the first photon counter.

An additional aspect of the invention relates to a method for radiometrically measuring the fill level. According to this method, the following steps are carried out in order to measure the fill level in a container. A signal emitted by a radioactive source is received by a scintillator arrangement of a fill level measurement device. In the following step, the received signals are converted into light signals by the scintillator arrangement. These light signals are received by a first and a second photon counter. The measurement signals generated from the light signals from the scintillator arrangement by the first and the second photon counter are compared with one another. This allows a change, caused by aging or temperature, in the measurement signals generated by the first photon counter to be detected. The measurement signals generated by the first photon counter are evaluated in the following step, taking into account the detected change caused by aging or temperature.

As described above and/or in the following, “taking into account the change, caused by aging or temperature, in the measurement signal generated by the first photon counter” should be understood to mean that a control means, for example the comparator or an additional control means of the fill level measurement device, can actuate the power supply unit for the first photon counter and can regulate the supply voltage to said first photon counter such that the measurement signal generated by the first photon counter re-assumes a predefined target value. On the other hand, it may also be provided that a correction factor is calculated from the comparison of the measurement signals obtained by the first and the second photon counter and is forwarded to the evaluation unit to be evaluated. In this case, the correction factor is taken into account when evaluating the measurement signal generated by the first photon counter.

It should be pointed out here that the method steps described above and/or in the following can be carried out by the fill level measurement device and that conversely all the features of the apparatus described above and/or in the following can also be implemented in the method.

According to another embodiment, the evaluation is carried out in the above-described method by following the steps described hereinafter: altering the supply voltage which is made available to the first photon counter by a power supply unit until the measurement signals obtained by the first and the second photon counter correspond, are at a specific target ratio to one another or lie within a tolerance interval. The measurement signals generated by the first photon counter are then evaluated by an evaluation unit. This does not require a correction factor to be transmitted the evaluation unit.

However, it may also be provided that the comparator is designed to alter the supply voltage to the first photon counter and can transmit a correction factor to the evaluation unit. An embodiment of this kind makes it possible to first compensate for a change, caused by aging or temperature, in the measurement signal generated by the first photon counter by altering the supply voltage to the first photon counter. If this compensation is insufficient, the difference obtained by comparing the measurement signal generated by the first and the second photon counter can be transmitted to the evaluation unit in the form of a correction factor.

According to another embodiment, the evaluation step in the above-described method comprises the following steps: determining a correction factor for the measurement signals generated by the first photon counter, this correction factor being computed from the comparison of the measurement signals generated by the first and the second photon counter. In the following step, the correction factor is transmitted to an evaluation unit and the measurement signal generated by the first photon counter is evaluated by the evaluation unit, taking into account the correction factor.

According to an additional aspect of the invention, a program element is proposed that can be executed on a processor of a fill level measurement device and instructs the fill level measurement device to carry out the steps specified in the following: Receiving a signal emitted by a radioactive source by means of a scintillator arrangement of a radiometric fill level measurement device. The scintillator arrangement converts the received signal into a quantity of light. Receiving the light signals generated in the scintillator arrangement by means of a first photon counter and receiving the light signals generated in the scintillator arrangement by means of a second photon counter. Comparing the measurement signals generated by the first and the second photon counter in order to be able to detect a change, caused by aging or temperature, in the measurement signal generated by the first photon counter. Evaluating the measurement signals generated by the first photon counter, taking into account the detected change caused by aging or temperature.

According to an additional aspect of the invention, a computer-readable medium is provided, on which an above-described program element is stored.

### BRIEF DESCRIPTION OF THE FIGURES

FIG. 1 shows an example of a radiometric fill level measurement device that is attached to an outer face of a container.

FIG. 2 shows an example of a radiometric fill level measurement device comprising a scintillator and two photon counters.

FIG. 3 shows an example of a radiometric fill level measurement device comprising two photon counters and a switch which makes it possible to use either the measurement signal generated by the first photon counter or the measurement signal generated by the second photon counter in order to measure the fill level.

FIG. 4 shows an example of a radiometric fill level measurement device comprising two scintillators and two photon counters.

FIG. 5 shows an example of a radiometric fill level measurement device comprising two photon counters, the comparator being connected to an input apparatus.

FIG. 6 shows a radiometric fill level measurement device, in which the comparator is also connected to a memory.

FIG. 7 shows a flow diagram of an evaluation method for ascertaining the fill level in a container using a radiometric till level measurement device comprising two photomultipliers.

The drawings are merely schematic and are not to scale. The same reference numerals denote the same or similar parts.

### DETAILED DESCRIPTION OF EMBODIMENTS

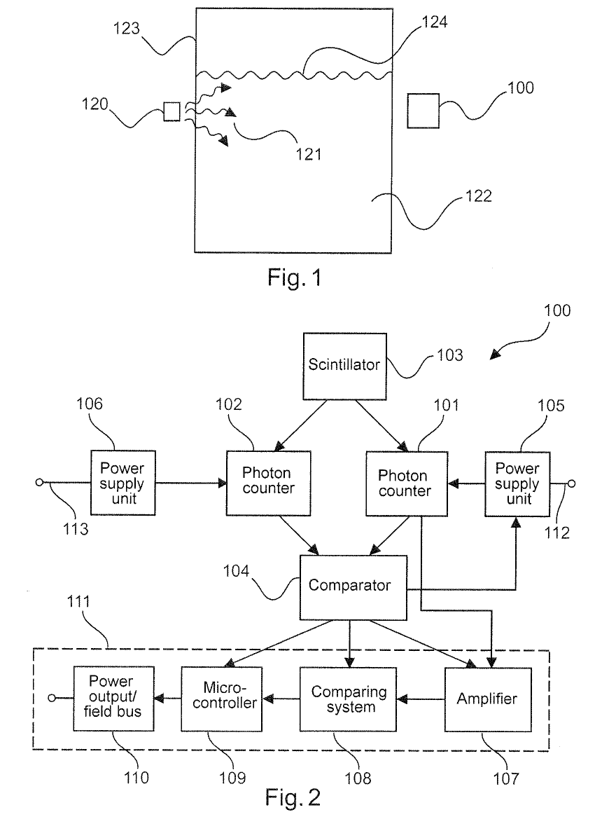

FIG. 1 shows a radiometric fill level measurement device 100 that is attached to an outer face of a container 123. A fluid or a filling material 122 is provided in the container at a specific filling level in the container and has a filling material surface 124. A transmitter 120 is attached to the outside of the container wall that is opposite the radiometric fill level measurement device. The transmitter comprises a radioactive source that emits gamma rays 121 in the direction of the container and in particular in the direction of the fill level measurement device arranged on the opposite outer container wall. Depending on its design, the radiometric fill level measurement device can be used to record the limit level, can allow for continuous fill level measurement or can be designed to measure the density or concentration of the filling material in the container.

FIG. 2 is a schematic view of a detailed construction of a radiometric fill level measurement device 100. The signals emitted by a radioactive source are first recorded in a scintillator 103 of the fill level measurement device 100 and converted into light signals in said scintillator. The scintillator can be connected to two photon counters. The first photon counter 101 can be designed as a photomultiplier, for example. A photomultiplier of this kind can have the sensitivity required for accurately capturing the light signal generated by the scintillator. The second photon counter 102 can be formed as an “avalanche photodiode”, for example. Other types of photon counters are, however, also conceivable for the first or the second photon counter. For example, the first and the second photon counter can be designed as a photomultiplier. In this case, the first photon counter 101 can be more sensitive than the second photon counter 102. The photon counters 101, 102 convert the light signal generated by the scintillator 103 into an electrical measurement signal that is recorded by a comparator 104. The comparator 104 is designed to compare the measurement signals generated by the photon counters with one another. In this case, the second photon counter can have a lower sensitivity but thus greater temperature stability, for example. A comparison of the measurement signals recorded by the first photon counter 101 and by the second photon counter 102 can, for example, be understood to mean the formation of the ratio of the signals to one another. In the absence of changes, caused by aging or temperature, in the measurement signals from the first photon counter 101, the ratio between the measurement signals assumes a predetermined target value, for example. If the ratio determined does not correspond to the target value, the comparator can be designed to actuate the power supply unit 105 for the first photon counter 101 in order to alter the supply voltage to the first photon counter 101. For this purpose, the power supply unit 105 for the first photon counter 101 is connected to a voltage source 112 for example. The supply voltage can be altered until a specific target value is obtained when comparing the measurement signals generated by the first and the second photon counter. Furthermore, the radiometric fill level measurement device comprises a second power supply unit 106 that supplies the supply voltage for the second photon counter 102. For this purpose, the second power supply unit 106 can be connected to a voltage source 113, for example.

According to the embodiment of a radiometric fill level measurement device shown in FIG. 2, the measurement signal generated by the first photon counter 101 can be transmitted to an evaluation unit 111 as soon as a specific target value is reached when the measurement signal generated by the first photon counter and the measurement signal generated by the second photon counter are compared by the comparator 104. The components of an evaluation unit 111 are shown in FIG. 2 by way of example. The evaluation unit can thus first of all be composed of an amplifier 107 which receives the measurement signal generated by the first photon counter 101 and amplifies it accordingly. The amplifier transmits the signal to a comparing system 108 which in turn forwards said signal to a microcontroller 109. The fill level or other variables to be deduced such as a concentration density of the filling material in the container can be determined, for example, by the microcontroller 109. The values determined or data derived can be provided at a connection point 110.

Furthermore, the comparator 104 can transmit data to the evaluation unit 111. In the embodiment of the evaluation unit 111 shown by way of example in FIG. 2, the comparator 104 can, for example, transmit data to the amplifier 107 or to the comparing system 108 or the microcontroller 109. For example, the comparator 104 can vary the supply voltage to the first photon counter 101 by actuating the power supply unit 105 until the ratio between the measurement signals determined by the first and the second photon counter approaches a target value without, however, being able to reach said target value. In this case, a correction factor can be deduced from the obtained actual ratio between the measurement signals generated by the first photon counter 101 and the second photon counter 102, which factor is made available to the evaluation unit 111. Said unit can then evaluate the measurement signals generated by the first photon counter 101, taking into account said correction factor. In an embodiment of this type, only the supply voltage for example can therefore be advantageously varied first of all. If this is insufficient, a correction factor can be determined and used when evaluating the measurement signal obtained by the first photon counter.

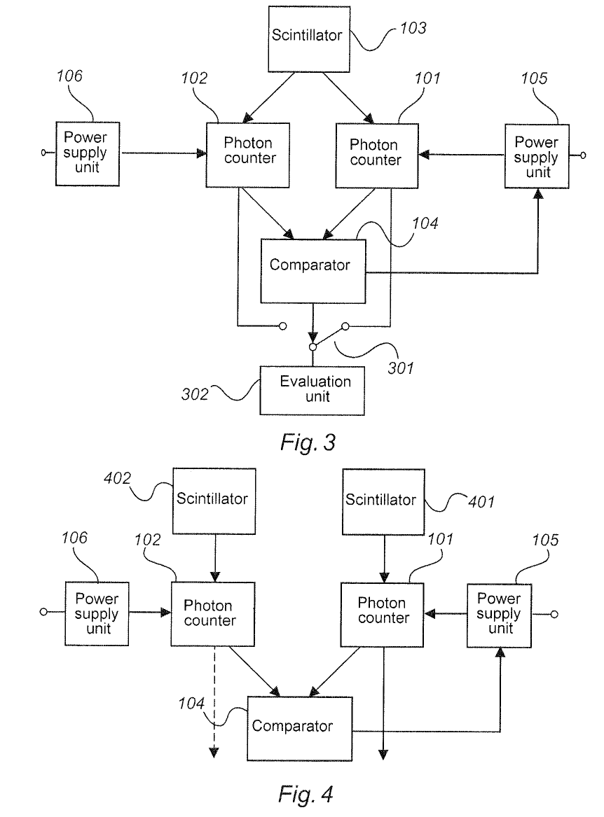

FIG. 3 shows another embodiment of a radiometric fill level measurement device comprising a scintillator 103 and a first photon counter 101 and a second photon counter 102, the measurement signals from which are each supplied to a comparator 104, the comparator 104 being designed, for example, to control the supply voltage to the first photon counter that is provided by a first power supply unit 105. Furthermore, the radiometric fill level measurement device comprises a second power supply unit 106 which is designed to supply power to the second photon counter 102. The comparator 104 is connected to a switch 301. The switch 301 has two switching states, the measurement signals generated by the first photon counter 101 being made available to an evaluation unit 302 in the first switching state. The measurement signals generated by the second photon counter can be transmitted to the evaluation unit 302 when the switch 301 is in the second switching state. The evaluation unit 302 can, for example, be in the form of the evaluation unit 111 and can comprise the components shown in FIG. 2. The embodiment shown in FIG. 3 makes it possible, for example, for the measurement signals generated by the first photon counter 101 to only be supplied to the evaluation unit 302 for further evaluation and in particular for ascertaining the fill level when the measurement signals generated by the first photon counter 101 have a particular quality factor. The quality factor can be determined by comparing said signals generated by the first photon counter with the measurement signals generated by the second photon counter 102, which comparison is carried out by the comparator 104. If the measurement signals generated by the first photon counter 101 fall below a predetermined quality factor, the switch 301 can be moved into its second position and the measurement signals generated by the second photon counter 102 are made available to the evaluation unit 302 for further evaluation. It can be provided that the switch 301 can be manually switched between the two switch positions, or the switch can be actuated and automatically switched, for example by the comparator. A combination of the two aforementioned options is also possible. For example, it is conceivable for the comparator 104 to automatically actuate the switch 301 in the event that a malfunction of the first photon counter 101 is detected and to prompt said switch to be moved into the second position, in which the measurement data from the second photon counter 102 can be supplied to the evaluation unit. In this way, if the first photon counter 101 were to fail or malfunction for example, it could be ensured that it is still possible to measure the fill level on the basis of the measurement signals generated by the second photon counter 102. Even if the second photon counter 102 has a lower degree of measurement accuracy or sensitivity than that of the first photon counter 101, for example, it can nevertheless therefore be ensured, for example if the first photon counter fails, that an (albeit less accurate) fill level measurement is possible. This is advantageous in that a complete failure of the radiometric fill level measurement device thus does not occur.

FIG. 4 is a partial view of a radiometric fill level measurement device 100 according to another embodiment. Two scintillators 401 and 402 are provided in this example. The light signals generated in the first scintillator 401 are recorded by a first photon counter 101 and converted into measurement signals that are supplied to a comparator 104. In a similar manner, the light signals generated in the second scintillator 402 are supplied to a second photon counter 102. The second photon counter 102 uses said light signals to generate measurement signals that are in turn supplied to the comparator 104. The comparator 104 can comprise a control apparatus for a power supply unit 105 which supplies voltage to the first photon counter 101. The additional components of the radiometric fill level measurement device shown in FIG. 4 can be designed according to the embodiments described above and/or in the following, for example.

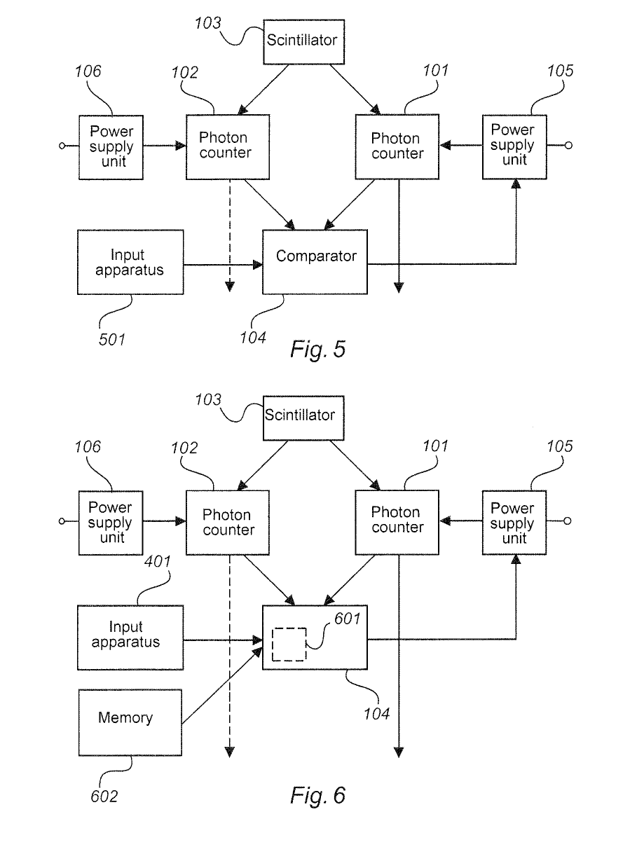

FIG. 5 shows another embodiment of a radiometric fill level measurement device 100. This is again a detail of the fill level measurement device. A scintillator 103 is shown, the light signals from which are received by a first photon counter 101 and a second photon counter 102. Said photon counters generate a measurement signal based on the received light signal, which measurement signal in turn is supplied to a comparator 104 in each case. According to the embodiment shown in FIG. 5, the comparator also comprises an input apparatus 501. The comparator 104 compares the measurement signals generated by the first and second photon counter. The input apparatus can be used to input a specific target value which is intended to be obtained during said comparison. It may also be provided that a certain interval can be input, within which the actual value determined by the comparator 104 is intended to lie. Furthermore, the comparator 104 can be designed to actuate the power supply unit 105 for the first photon counter 101 and to prompt the power supply unit 105 to alter the supply voltage to the first photon counter 101 until the actual value ascertained by the comparator lies within an interval that has either been previously input into the input apparatus or defined in some other way. The measurement signal generated by the first photon counter 101 can then be transmitted to an evaluation unit, for example, in accordance with an embodiment described above and/or in the following. The fill level measurement device in FIG. 5 can also comprise a switch, shown in FIG. 3, such that when the switch is in the corresponding position, the measurement signals generated by the second photon counter are also transmitted to the evaluation unit, for example.

FIG. 6, like FIG. 5, shows a detail of a radiometric fill level measurement device 100. In addition to the components shown in FIG. 5, the fill level measurement device in FIG. 6 comprises a memory 602 that is connected to the comparator 104. The comparator 104 may also comprise an internal memory 601. A temperature characteristic curve for a photodiode can be stored in the memory 602 or the internal memory 601, for example. In this case, under known operating conditions, i.e. a known operating temperature for example, it may be possible to input the operating temperature into the input apparatus 401. In this case, the comparator 104 can use the temperature characteristic curve for a photodiode which is stored in the memory 602 or in the memory 601 and is used, for example, in the radiometric fill level measurement device as the first photon counter 101 or as the second photon counter 102. As a result, changes to a measurement signal generated in each case that are caused by temperature can be advantageously taken into account.

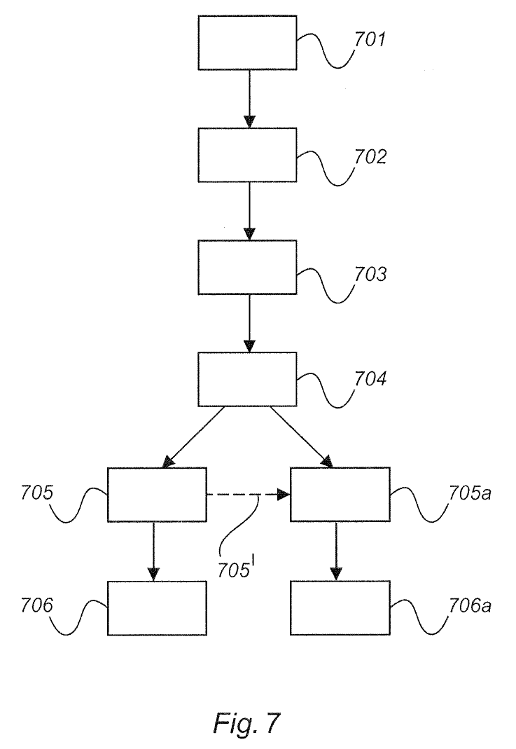

FIG. 7 shows a flow diagram illustrating the method used to radiometrically measure the fill level using a fill level measurement device described above and/or in the following. The method is based on the steps described below. In the first step 701, a signal is emitted by a radioactive transmission unit. This signal is received in the second step 702 by a scintillator arrangement of a radiometric fill level measurement device 100. The scintillator arrangement may be a scintillator, for example. However, it can also be provided that the radiometric fill level measurement device comprises two scintillators, each of which receives a signal. A light signal is generated in the scintillator or scintillators on the basis of the signal received. In the following step 703, this light signal is transmitted to two photon counters that generate an electrical measurement signal from the light signal received. In the following step 704, the measurement signals generated by the first photon counter 101 and the second photon counter 102 are supplied to a comparator 104, which compares them. The measurement signal generated by the first photon counter is evaluated in the following method steps on the basis of this comparison. Various evaluation options are available in this regard.

The first option consists in varying the supply voltage to the first photon counter 101 in the step 705 in order to compensate for the effect of temperature or aging detected when the measurement signals were compared in step 704. In step 706, the measurement signal recorded by the first photon counter 101 can then be evaluated by an evaluation unit.

Alternatively, the step 704 can be followed by the step 705a, in which a correction factor is determined on the basis of the comparison of the measurement signals determined by the first photon counter and the second photon counter. This correction factor is delivered to an evaluation unit. The measurement signal generated by the first photon counter 101 is then evaluated in step 706a, taking into account the correction factor.

A third option for an evaluation method consists in that, proceeding from step 704, the supply voltage to the first photon counter is first varied in step 705. If the supply voltage could not be altered in such a way that a target value was achieved when the measurement signals generated by the first and the second photon counter were compared, a correction factor can be determined in step 705′ and in turn delivered to the evaluation unit. On this basis, the measurement signal generated by the first photon counter is in turn evaluated in step 706a, taking into account the correction factor determined in step 705′. The last-described evaluation option can be provided if it is not possible to make the measurement signals generated by the first and the second photon counter correspond by varying the supply voltage to the first photon counter, or if the actual value from the comparison of the measurement signals generated does not fall within a target interval. In this case, a remaining correction factor can be determined that demonstrates or reflects the difference remaining between the measurement signals. This correction factor is then delivered to the evaluation unit in order to be taken into account during further evaluation.

It should additionally be pointed out that “comprising” does not exclude the possibility of further elements or steps, and “a”, “an” or “one” does not exclude the possibility of a plurality. It should further be pointed out that features or steps described with reference to one of the above embodiments may also be used in combination with other features or steps of other above-described embodiments. Reference numerals in the claims are not to be regarded as limitations.

1. A fill level measurement device for radiometrically measuring a fill level, comprising:
a first photon counter;
a second photon counter;
a comparator, and
an evaluation unit;
wherein the comparator is configured to compare the measurement signals generated by the first photon counter and the second photon counter in order to detect a change, caused by aging or temperature, in the measurement signals generated by the first photon counter; and
wherein the evaluation unit is configured to evaluate the measurement signals generated by the first photon counter, taking into account the detected change caused by aging or temperature.

2. The fill level measurement device according to claim 1, wherein the second photon counter is temperature-stable.

3. The fill level measurement device according to claim 1, wherein the first photon counter is a photomultiplier.

4. The fill level measurement device according to claim 1, wherein the second photomultiplier is an avalanche photodiode.

5. The fill level measurement device according to claim 1, further comprising:
a scintillator arrangement including first and second scintillators;
wherein the first photon counter receives light signals from the first scintillator;
wherein the second photon counter receives light signals from the second scintillator.

6. The fill level measurement device according to claim 1, further comprising:
a scintillator arrangement including a scintillator;
wherein the first and second photon countersreceive light signals from the scintillator.

7. The fill level measurement device according to claim 1, further comprising:
a power supply unit providing the supply voltage to the first photon counter; and
a control unit configured to alter the supply voltage to the first photon counter that is provided by the power supply unit in the event that a change caused by aging or temperature is detected, in order to compensate for the change.

8. The fill level measurement device according to claim 1, wherein the comparator determines a correction factor to evaluate the measurement signals generated by the first photon counter on the basis of the result of the comparison of the measurement signals recorded by the first and the second photon counter and wherein the comparator transmits the correction factor to the evaluation unit.

9. A method for radiometrically measuring a fill level, comprising:
receiving a signal emitted by a radioactive source using a scintillator arrangement;
receiving light signals from the scintillator arrangement using a first photon counter and a second photon counter;
comparing the measurement signals generated by the first photon counter and the second photon counter in order to detect a change, caused by aging or temperature, in the measurement signals generated by the first photon counter; and
evaluating the measurement signals generated by the first photon counter, taking into account the detected change caused by aging or temperature.

10. The method according to claim 9, wherein the scintillator arrangement includes a first scintillator and a second scintillator, the first and second scintillators receiving the signals from a radioactive source; wherein the first photon counter receives light signals from the first scintillator; and wherein the second photon counter receives light signals from the second scintillator.

11. The method according to claim 9, wherein the evaluating step includes the following substeps:
altering a supply voltage to the first photon counter until the measurement signals generated by the first and the second photon counters correspond, assume a specific target value or a specific ratio to one another or are within a certain predefined interval, wherein a power supply unit supplies the supply voltage to the first photon counter, and
evaluating the measurement signals generated by the first photon counter using an evaluation unit.

12. The method according to claim 10, wherein the evaluating step includes the following substeps:
altering a supply voltage to the first photon counter until the measurement signals generated by the first and the second photon counters correspond, assume a specific target value or a specific ratio to one another or are within a certain predefined interval, wherein a power supply unit supplies the supply voltage to the first photon counter, and
evaluating the measurement signals generated by the first photon counter using an evaluation unit.

13. The method according to claim 9, wherein wherein the evaluating step includes the following substeps:
determining a correction factor for the measurement signals that are generated by the first photon counter on the basis of the comparison of the measurement signals generated by the first and the second photon counter;
transmitting the correction factor to an evaluation unit;
evaluating the measurement signals generated by the first photon counter, taking into account the correction factor, using the evaluation unit.

14. The method according to claim 10, wherein wherein the evaluating step includes the following substeps:
determining a correction factor for the measurement signals that are generated by the first photon counter on the basis of the comparison of the measurement signals generated by the first and the second photon counter;
transmitting the correction factor to an evaluation unit;
evaluating the measurement signals generated by the first photon counter, taking into account the correction factor, using the evaluation unit.

15. A program element which, when executed on a processor of a fill level measurement device, instructs the device to carry out the following steps:
receiving light signals from a scintillator arrangement using a first photon counter and a second photon counter;
comparing the measurement signals generated by the first and second photon counters in order to detect a change, caused by aging or temperature, in the measurement signals generated by the first photon counter; and
evaluating the measurement signals generated by the first photon counter, taking into account the detected change caused by aging or temperature.

16. A computer-readable medium on which a program element according to claim 15 is stored.
